(19) United States
(12) Patent Application Publication
(10) Pub. No.: US 2016/0247457 A1
(43) Pub. Date: Aug. 25, 2016

(54) DISPLAY PANEL, DISPLAY DEVICE INCLUDING THE SAME AND OPERATION METHOD THEREOF

(71) Applicant: ELECTRONICS AND TELECOMMUNICATIONS RESEARCH INSTITUTE, Daejeon (KR)

(72) Inventors: Joo Yeon KIM, Daejeon (KR); Sang Hoon CHEON, Daejeon (KR); Hyunkoo LEE, Daejeon (KR); Byoung-Hwa KWON, Daejeon (KR); Jaehyun MOON, Daejeon (KR); Seung Koo PARK, Daejeon (KR); Byoung Gon YU, Yeongdong-gun (KR); JEONG IK LEE, Daejeon (KR); Jong Tae LIM, Seoul (KR); Hye Yong CHU, Daejeon (KR); Jun-Han HAN, Daejeon (KR)

(21) Appl. No.: 15/047,357

(22) Filed: Feb. 18, 2016

(30) Foreign Application Priority Data
Feb. 23, 2015 (KR) 10-2015-0025284

(51) Int. Cl. G09G 3/32; G09G 3/36; G09G 3/20

(52) U.S. Cl. CPC G09G 3/3291; G09G 3/2003; G09G 3/3607; G09G 2360/141; G09G 2360/144; G09G 2320/0233

(57) ABSTRACT

A display panel includes pixels, the pixels being configured to be driven in either a reflection mode or a light emission mode, the pixels comprises a first substrate comprising a light-transmitting material, a second substrate opposite to the first substrate, a light emitting element layer on the first electrode, the light emitting element layer comprising a light emitting material, the light emitting material being configured to emit light in the light emission mode by an oxidation of the light emitting material and a reduction of the light emitting material, a second electrode on a surface of the second substrate in a direction of the first substrate, a reflective element layer on the second electrode, the reflective element layer comprising a reflective material, the reflective material being configured to be colored or bleached in the reflection mode by an oxidation of the reflective material and a reduction of the reflective material.

### CROSS-REFERENCE TO RELATED APPLICATIONS

The present claims priority under 35 U.S.C. §119 of Korean Patent Application No. 10-2015-0025284, filed on Feb. 23, 2015, the entire contents of which are hereby incorporated by reference.

### TECHNICAL FILED

The present disclosure herein relates to a display device, and more particularly, to a display device capable of light emission driving or reflection driving and an operation method thereof.

### DESCRIPTION OF THE RELATED ART

According to rapid development of information and communication industry, the use of display devices is rapidly increasing. Recently, a display device capable of satisfying conditions of low power, light weight, thin shape, and high resolution is demanded. According to such a demand, liquid crystal display devices (LCDs) or organic light emitting display devices (OLEDs) using organic light emitting characteristics are being developed.

The OLED is a next generation display device having self-emissive characteristic. The OLED exhibits excellent performance in an aspect of angle of field, contrast, response speed, and power consumption, compared to an LCD. In addition, since the OLED does not need a backlight, it may be lightly and thinly manufactured.

Such the OLED exhibits excellent contrast performance compared to an LCD. However, when external light having a predetermined intensity or higher is incident thereto, visibility of the OLED may be lowered. In order to improve this, a reflection—light emission composite display device has been proposed in which an organic light emission mode and a reflective liquid crystal mode are combined.

### SUMMARY

The present disclosure provides a display panel comprising: a plurality of pixels, each of the plurality of pixels being configured to be driven in either a reflection mode or a light emission mode, wherein each of the plurality of pixels comprises: a first substrate comprising a light-transmitting material, a second substrate opposite to the first substrate, a first electrode on a surface of the first substrate in a direction of the second substrate, a light emitting element layer on the first electrode, the light emitting element layer comprising a light emitting material, the light emitting material being configured to emit light in the light emission mode by an oxidation of the light emitting material and a reduction of the light emitting material, a second electrode on a surface of the second substrate in a direction of the first substrate, a reflective element layer on the second electrode, the reflective element layer comprising a reflective material, the reflective material being configured to be colored or bleached in the reflection mode by an oxidation of the reflective material and a reduction of the reflective material, and an electrolyte layer between the light emitting element layer and the reflective element layer, the electrolyte layer being configured to adjust transmissivity of the light, wherein in the reflection mode, a first alternating current (AC) voltage having a frequency lower than or equal to a first frequency is applied to the first and second electrodes, wherein in the light emission mode, a second AC voltage having a frequency higher than or equal to a second frequency is applied to the first and second electrodes, and wherein the second frequency is higher than the first frequency.

In an embodiment, in the reflection mode: when a first reflection voltage is applied to the first and second electrodes, the reflective material is colored by the reduction of the reflective material, and when a second reflection voltage is applied to the first and second electrodes, the reflective material is bleached by the oxidation of the reflective material, and wherein the first reflection voltage is a negative voltage and the second reflection voltage is a positive voltage.

In an embodiment, the reflective material is colored by one of red, green, blue, and black, and wherein the reflective material reflects the light applied from an outside.

In an embodiment, in the light emission mode: when a first light emission voltage is applied to the first and second electrodes, the reduction of the light emitting material occurs at the light emitting element layer, and when a second light emission voltage is applied to the first and second electrodes, the oxidation of the emitting material occurs at the light emitting element layer, wherein the light emitting element layer emits the light by the oxidation of the light emitting material and the reduction of the light emitting material, and wherein the first light emission voltage is a negative voltage and the second emission voltage is a positive voltage.

In an embodiment, an average voltage of the first and second light emission voltages is higher than or equal to 0 V.

In an embodiment, a display device further comprises a first insulating layer between the first substrate and the first electrode, and a second insulating layer between the second substrate and the second electrode.

In an embodiment, a display device further comprises a plurality of spacers between the first and second substrates.

The present disclosure provides operation method of a display device, the display device being configured to be driven in either a reflection mode or a light emission mode, the operation method comprising: measuring, by an optical sensor of the display device, an illumination of a light source, comparing, by a timing controller of the display device, a reference value with the illumination, in response to the illumination being compared to be greater than the reference value, applying, by the timing controller of the display device, a first alternative current (AC) voltage having a frequency lower than or equal to a first frequency to a first electrode and a second electrode of each pixel of the display device to realize the reflection mode, and displaying image information on the display device according to the first AC voltage.

In an embodiment, the method further comprises in response to the illumination being compared to be smaller than or equal to the reference value, applying a second AC voltage having a frequency higher than or equal to a second frequency to the first electrode and the second electrode of the each pixel to realize the light emission mode.

In an embodiment, the second frequency has a higher level than a level of the first frequency.

The present disclosure provides a display device comprising: a display panel comprising a plurality of pixels, each of the plurality of pixels being configured to be driven in either a reflection mode or a light emission mode, and a circuit board configured to: sense a light source, compare an illumination of the light source with a reference value and generate a comparison result, and adjust a first alternating current (AC) voltage and a second AC voltage applied to the plurality of pixels in response to the comparison result, wherein each of the plurality of pixels comprises: a first substrate comprising a light-transmitting material, a second substrate opposite to the first substrate, a first electrode on a surface of the first substrate in a direction of the second substrate, a light emitting element layer on the first electrode, the light emitting element layer comprising a light emitting material, the light emitting material being configured to emit light in the light emission mode by an oxidation of the light emitting material and a reduction of the light emitting material, a second electrode on a surface of the second substrate in a direction of the first substrate, a reflective element layer on the second electrode, the reflective element layer comprising a reflective material, the reflective material being configured to be colored and bleached in the reflection mode by an oxidation of the reflective material and a reduction of the reflective material, and an electrolyte layer between the light emitting element layer and the reflective element layer, the electrolyte layer being configured to adjust transmissivity of the light, wherein when the illumination is greater than the reference value, the first AC voltage having a frequency lower than or equal to a first frequency is applied to the first and second electrodes to drive the plurality of pixels in the reflection mode, wherein when the illumination is smaller than or equal to the reference value, the second AC voltage having the frequency higher than or equal to a second frequency is applied to the first and second electrodes to drive the plurality of pixels in the light emission mode, and wherein the second frequency is higher the first frequency.

### BRIEF DESCRIPTION OF THE DRAWINGS

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a block diagram of a display device according to an embodiment;

FIG. 2 is a cross-sectional view showing a lamination structure of a pixel according to a first embodiment;

FIG. 3 is a cross-sectional view showing a lamination structure of a pixel according to a second embodiment;

FIG. 4 is a graph showing a voltage signal applied in a reflection mode according to an embodiment;

FIG. 5 is a graph showing a voltage signal applied in a reflection type mode according to an embodiment;

FIG. 6 is a flowchart showing an operation method of a display device according to an embodiment; and

FIG. 7 is a graph showing a voltage signal applied in a composite mode according to an embodiment.

### DETAILED DESCRIPTION OF EMBODIMENTS

Example embodiments will be described in detail with reference to the accompanying drawings. The present invention may be variously modified and realized in various forms, and thus specific embodiments will be exemplified in the drawings and described in detail hereinbelow. However, the present invention is not limited to the specific disclosed forms, and needs to be construed to include all modifications, equivalents, or replacements included in the spirit and technical range of the present invention. Like reference numerals refer to like elements throughout. In the drawings, the dimensions of structures are exaggerated for clarity of illustration. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the singular forms “a,” “an” and “the” are intended to include the plural forms as well, unless the context clearly indicates otherwise.

It will be further understood that the terms “comprises”, “comprising,”, “includes” and/or “including”, when used herein, specify the presence of stated features, integers, steps, operations, elements, components or combinations thereof, but do not preclude the presence or addition of one or more other features, integers, steps, operations, elements, components, or combinations thereof. It will also be understood that when a part such as a layer, a film, a region, or a plate, etc., is referred to as being ‘on’ another part, it can be “directly on” the other part, or intervening part may also be present. On the contrary, it will be understood that when a part such as a layer, a film, a region, or a plate, etc., is referred to as being ‘under’ another part, it can be “directly under”, and one or more intervening parts may also be present.

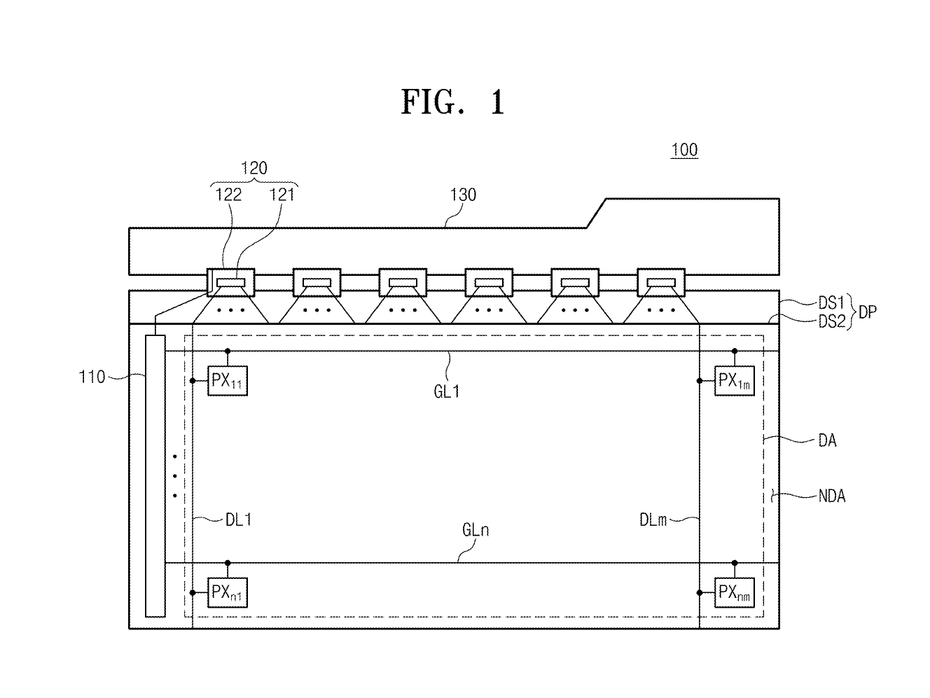

FIG. 1 is a block diagram of a display device according to an embodiment. Referring to FIG. 1, a display device 100 may include a display panel DP and a gate driving circuit 110, a data driving circuit 120, and a circuit board 130.

The display panel DP according to an embodiment may include a first substrate DS1 and a second substrate DS2. The display panel DP may include a plurality of gate lines GL1 to GLn and a plurality of data lines DL1 to DLm intersecting with the gate lines GL1 to GLn, which are disposed on the first substrate DS1. The gate lines GL1 to GLn are connected to the gate driving unit 110 and may receive sequential gate signals. The plurality of data lines DL1 to DLm are connected to the data driving circuit 120 and receive analog type data signals (or data voltages).

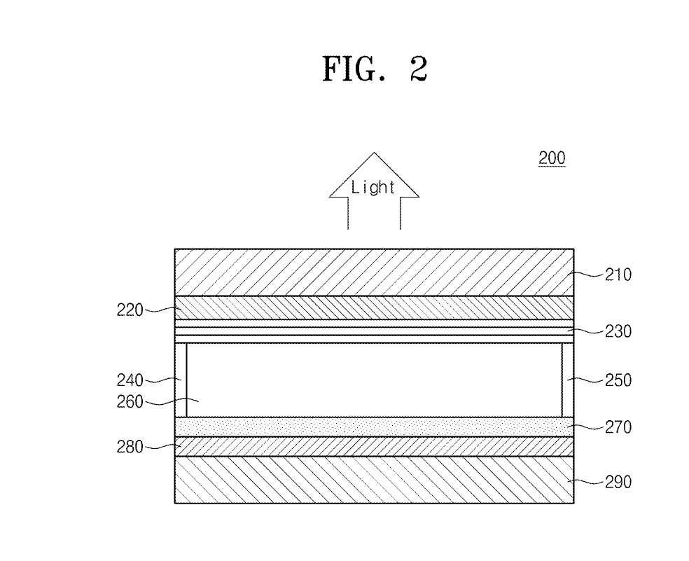

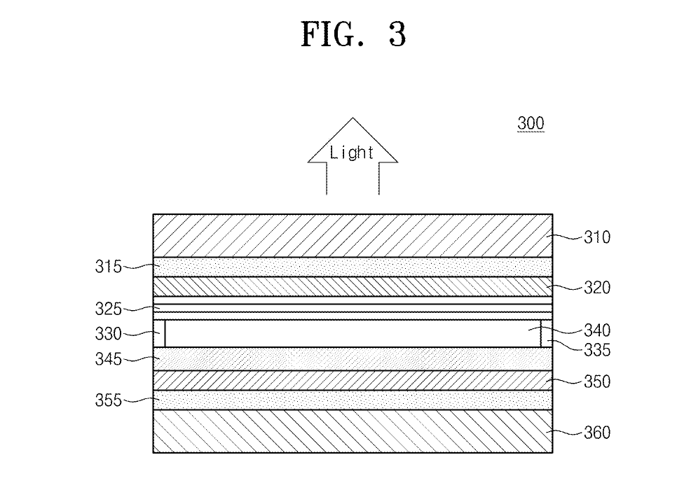

The second substrate DS2 may selectively realize a reflection mode and a light emission mode. For example, the second substrate DS2 may be defined by a liquid crystal display panel and an organic light emitting display panel. The second substrate DS2 may be divided into a display area DA provided with a plurality of pixels PX11 to PXnm and a non-display area NDA surrounding the display area DA. Plurality of pixels PX11 to PXnm of the second substrate DS2 according to an embodiment will be described with respect to FIGS. 2 and 3.

The plurality of pixels PX11 to PXnm are respectively connected to corresponding gate lines among the plurality of gate lines GL1 to GLn and corresponding data lines among the plurality of data lines DL1 to DLm.

The gate driving circuit 110 is connected to the pixels P11 to PXnm through the gate lines GL1 to GLn. The gate driving circuit 110 may receive a gate control signal from a timing controller (not illustrated) mounted on the circuit board 130. The gate driving circuit 110 may be provided at the same time with the pixels PX11 to PXnm through a thin film process. For example, the gate driving circuit 110 may be mounted in an amorphous silicon TFT gate driver circuit type on the non-display area NDA.

Referring to FIG. 1, the gate driving circuit 110 is connected to left end terminals of the gate lines GL1 to GLn, but is not limited thereto. The display device 100 may include two gate driving circuits. One of the two gate driving circuits may be connected to the left end terminals of the plurality of gate lines GL1 to GLn and the other may be connected to the right end terminals of the plurality of gate lines GL1 to GLn. For example, one of the two gate driving circuits may be connected to odd numbered gate lines and the other may be connected to even numbered gate lines.

The data driving circuit 120 may receive data signals from the timing controller (not illustrated) mounted on the circuit board 130 and generates analog data signals corresponding to the data signals. In addition, the data driving circuit 120 may receive control signals for controlling the pixels PX11 to PXnm from the timing controller (not illustrated). The control signals may be signals for controlling a reflection mode or a light emission mode of the pixels PX11 to PXnm. The data driving circuit 120 may generate analog controls signals.

The data driving circuit 120 may include a driving chip 121 and a flexible circuit board 122 on which the driving chip 121 is mounted. The driving chip 121 and the flexible circuit board 122 may be respectively provided in plural numbers. The flexible circuit board 122 electrically connects the circuit board 130 and the first substrate DS1. The driving chip 121 may respectively provide data signals to the data lines DL1 to DLm.

FIG. 1 exemplarily illustrates a data driving circuit 120 in a tape carrier package (TCP) type. However, the data driving circuit 120 may be mounted on the first substrate DS1 in a chip on glass (COG) manner.

The circuit board 130 may include the timing controller (not illustrated) providing a gate control signal, a data control signal, and a data signal. In addition, the circuit board 130 may include an optical sensor (not illustrated). The optical sensor (not illustrated) may sense an external light source. The optical sensor (not illustrated) may deliver illumination information according to illumination of the sensed external light source to the timing controller (not illustrated). The timing controller (not illustrated) may drive the pixels PX11 to PXnm in a reflection mode or a light emission mode according to the illumination information. The timing controller (not illustrated) may supply an AC voltage for driving the pixels PX11 to PXnm in a reflection mode or a light emission mode. To this end, in some embodiments, the timing controller may include one or more voltage generator circuits.

As described above, the display device 100 may sense the external light and selectively drive the pixels PX11 to PXnm in either the reflection mode or the light emission mode according to the illumination of the external light source. An emissive display device may have high visibility in a dark external environment. However, in a bright external environment, the visibility of the emissive display device is lowered. Improvement in visibility of the emissive display device may consume much power in the bright external environment. On the other hand, the reflective display device may have higher visibility in a bright external environment than in a dark external environment. Accordingly, when the pixels PX11 to PXnm are selectively driven in either the reflection mode or light emission mode according to the illumination of the external light source, the visibility of the display device 100 may be improved. In addition, power consumption of the display device 100 may be reduced.

FIG. 2 is a cross-sectional view showing a lamination structure of a pixel according to a first embodiment. Referring to FIGS. 1 and 2, the pixels PX11 to PXnm may have the same structure as that of a pixel 200 of FIG. 2. The pixel 200 may include a first substrate 210, a first electrode 220, a light emitting element layer 230, first and second spacers 240 and 250, an electrolyte layer 260, a reflective element layer 270, a second electrode 280, and a second substrate 290.

The first substrate 210 may be provided with an insulating substrate. For example, the first substrate 211 may be provided with a glass substrate. The first substrate 220 may be a substrate of a display surface side of the pixel 200. Accordingly, the second substrate 210 may be provided with a transparent glass substrate or a transparent plastic substrate.

The first electrode 220 may be a transparent electrode. The first electrode 220 may be provided on a bottom portion of the first substrate 210. The first electrode 220 may be defined by a metal, a nonmetal, or an oxide. For example, the first electrode 220 may be made of indium tin oxide (ITO), indium zinc oxide (IZO), or transparent conductive oxide (TCO). The transmissivity of the first electrode 220 satisfies 70% or higher.

The light emitting element layer 230 may be made of a material, which emits light by undergoing an electrochemical oxidation or reduction. The light emitting element layer 230 may be made of an electrochemiluminescence (ECL) material. The light emitting element layer 230 may be made of a polynuclear aromatic compound, a heteroaromatic compound, or an organic metal compound. The light emitting element layer 230 may oxidize or may reduce, and may emit light by an AC voltage supplied through the first and second electrodes 220 and 280.

The first and second spacers 240 and 250 may support between the first and second substrates 210 and 290. The first and second spacers 240 and 250 may adjust an interval between the first and second substrates 210 and 290. The electrolyte layer 260 may be provided between the light emitting element layer 230 and the reflective element layer 240. The electrolyte 260 may be provided in a transparent liquid, solid, or gel type. In the electrolyte layer 260, an oxidation or a reduction occurs according to an AC voltage supplied through the first and second electrodes 220 and 280, and transmissivity thereof is adjusted by the oxidation or reduction. Accordingly, the electrolyte layer 260 may adjust an amount of light incident to the reflective element layer 270 or an amount of light reflected from the reflective element layer 270.

The reflective element layer 270 may be provided with a reflective element. For example, the reflective element layer 270 may be provided with a material colored or bleached through the electrochemical oxidation or reduction. In detail, the oxidation or reduction phenomenon may occur in the reflective element layer 270 according to voltages applied to the first and second substrates 210 and 290. The reflective element layer 270 is colored red, green, blue, or black through the reduction. In addition, the reflective element layer 270 may be a material, which is bleached to be transparent by the oxidation. For example, as a material of the reflective element layer 270, an inorganic low molecular matter or a conductive polymer may be used. The reflective element layer 270 may be provided in a deposition, sputtering, vapor phase growth, coating, and drying manner.

The second electrode 280 may be a transparent electrode. The second electrode 280 may be provided in a bottom portion of the reflective element layer 250. The second electrode 280 may be defined by a metal, a nonmetal, or an oxide. For example, the second electrode 280 may be made of indium tin oxide (ITO), indium zinc oxide (IZO), or transparent conductive oxide (TCO). The transmissivity of the second electrode 280 satisfies 70% or higher.

The second substrate 290 may be provided on a bottom portion of the second electrode 280. The second substrate 290 may be provided as an insulating substrate. For example, the second substrate 290 may be provided with a glass substrate or a plastic substrate. However, since not being a display part of the pixel 200, the second substrate 290 is made of non-transparent material.

According to an embodiment, the pixel 200 may be selectively driven in a reflection mode or a light emission mode according to an AC voltage applied to the first and second electrodes 220 and 280. AC voltage may receive from the circuit board 130. For example, when an AC voltage having a frequency lower than or equal to a first frequency may be applied to the first and second electrodes 220 and 280, the pixel 200 may be driven in the reflection mode. The first frequency may be about 1 Hz. In addition, when an AC voltage having the frequency higher than or equal to a second frequency may be applied to the first and second electrodes 220 and 280, the pixel 200 may be driven in the light emission mode. The second frequency may be about 10 Hz.

FIG. 3 is a cross-sectional view showing a lamination structure of a pixel according to a second embodiment. Referring to FIGS. 1 and 3, the pixels PX11 to PXnm may have the same structure as that of a pixel 300 of FIG. 3. Referring to FIGS. 2 and 3, the pixel 300 of FIG. 3 may have a structure in which first and second insulation layers 315 and 355 are added to the pixel 200 of FIG. 2.

The pixel 300 may include a first substrate 310, a first organic layer 315, a first electrode 320, a light emitting element layer 325, first and second spacers 330 and 335, an electrolyte layer 260, a reflective element layer 345, a second electrode 350, a second organic layer 355, and a second substrate 360.

The first and second insulation layers 315 and 355 are thin layers having a height in a micro (μ) unit or a nano (n) unit. The first and second insulating layers 315 and 355 may be provided through a printing method which uses molding like an imprinting scheme or a micro contact scheme. In addition, the height and width of the first and second insulating layers 315 and 355 may be determined at the time of spin coating.

According to an embodiment, the pixel 300 of FIG. 3 may be selectively driven in a reflection mode or a light emission mode according to an AC voltage applied to the first and second electrodes 320 and 350. For example, when an AC voltage having a frequency higher than or equal to a first frequency is applied to the first and second electrodes 320 and 350, the pixel 300 may be driven in the reflection mode. The first frequency may be about 1 Hz. In addition, when an AC voltage having the frequency lower than or equal to a second frequency is applied to the first and second electrodes 320 and 350, the pixel 300 may be driven in the light emission mode. The second frequency may be about 10 Hz.

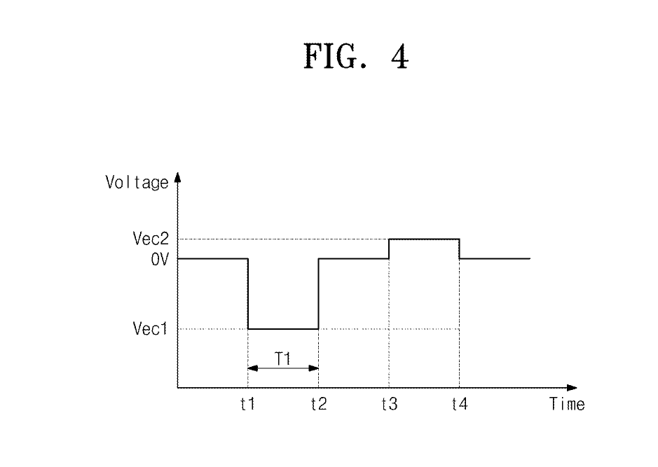

FIG. 4 is a graph showing a voltage signal applied in a reflection mode according to an embodiment. Referring to FIGS. 1 to 4, in the reflection mode, an AC voltage as shown in FIG. 4 is applied to the pixels PX11 to PXnm.

In detail, when the reflection mode is realized, AC voltages having a frequency lower than or equal to a first frequency are applied to the first electrodes 220 and 320 and the second electrodes 280 and 350 of the pixels 200 and 300. For example, the first frequency is about 1 Hz.

At a first time t1, a first reflection voltage Vec1 may be applied to the first electrodes 220 and 320 and the second electrodes 230 and 350. The first reflection voltage Vec1 may be a negative voltage. When the first reflection voltage Vec1 is applied, a reduction may occur in a material defining the reflective element layers 270 and 345. Due to the reduction, the reflective element layers 270 and 345 may be colored red, green, blue, or black. External light is reflected by the colored reflective element layers 270 and 345 to display image information. The first reflection voltage Vec1 may be applied till a second time t2. In other words, the first reflection voltage Vec1 is applied during a first period T1.

From the second time t2 to a third time t3, a voltage of 0 V may be applied to the first electrodes 220 and 320 and the second electrodes 280 and 350. Then the reduction occurs in the material defining the reflective element layers 270 and 345. Accordingly, in this period, the reflective element layers 270 and 345 continuously exhibit the reflection mode.

From the third time t3 to a fourth time t4, a second reflection voltage Vec2 is applied to the first electrodes 220 and 320 and the second electrodes 230 and 350. The second reflection voltage Vec2 may be a positive voltage. When the second reflection voltage Vec2 is applied, an oxidation occurs in a material defining the reflective element layers 270 and 345. Due to the oxidation, the reflective element layers 270 and 345 may be bleached to a transparent state.

Referring to FIG. 4, each of the first reflection voltage Vec1, 0 V, and the second reflection voltage Vec2, which are applied to the first electrodes 220 and 320, and the second electrodes 280 and 350, may be applied with a first frequency or lower.

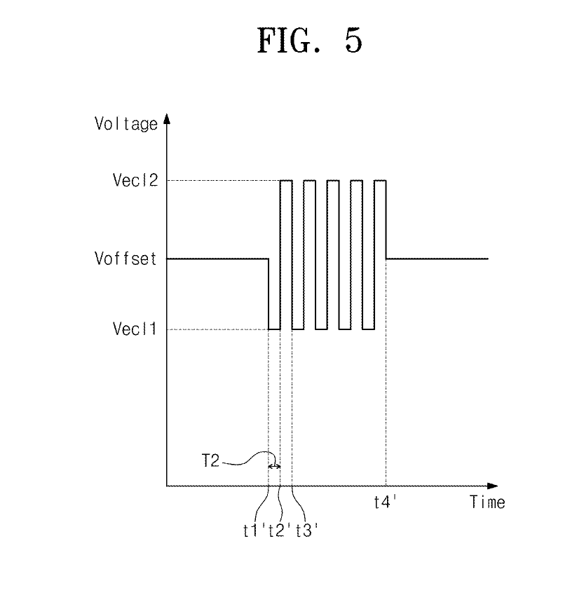

FIG. 5 is a graph showing a voltage signal applied in a reflection type mode according to an embodiment. Referring to FIGS. 1 to 3, and 5, in the reflection mode, an AC voltage as shown in FIG. 5 is applied to the pixels PX11 to PXnm.

In detail, when the reflection mode is realized, AC voltages having the frequency higher than or equal to a second frequency is applied to the first electrodes 220 and 320 and the second electrodes 280 and 350 of the pixels 200 and 300. For example, the second frequency is about 10 Hz.

At a first time t1′, a light emission voltage Vec11 may be applied to the first electrodes 220 and 320 and the second electrodes 230 and 350. The first light emission voltage Vec11 may be a negative voltage. When the first light emission voltage Vec11 is applied, electrons are injected into a material defining the reflective element layers 230 and 325 and a reduction occurs. Due to the reduction, radical anions are generated from phosphor, which develops a color of green, blue, or white, of the light emission layers 230 and 325. The first light emission voltage Vec11 is applied till a second time t2′. In other words, the first light emission voltage Vec11 is applied during a second period T2.

At a second time t2, a second light emission voltage Vec12 is applied to the first electrodes 220 and 320 and the second electrodes 230 and 350. The second light emission voltage Vec12 may be a positive voltage. When the second light emission voltage Vec12 is applied, the electrons, which have been injected into the material of the light emitting element layers 230 and 325, move to the first electrodes 220 and 320 and the second electrodes 280 and 350, and are reduced. Due to the reduction, radical cations are generated in the phosphor of the light emitting element layers 230 and 325. The second light emission voltage Vec12 is applied till a third time t3′.

The radial cations and radical anions, which are generated in the light emitting element layers 230 and 325 by the first and second light emission voltages Vec11 and Vec12, collide to be recombined. At this point, recombination energy generated by the recombination may make the phosphor of the light emitting element layers 230 and 325 may be in an excited state. The phosphors of the light emitting element layers 230 and 325, which are in the excited state, may emit light.

Referring to FIG. 5, from the first time t1′ to the fourth time t4′, the first and second light emission voltages Vec11 and Vec12 may be applied to the first electrodes 220 and 320 and the second electrodes 280 and 350 with a second frequency. After a fourth time t4′, when an offset voltage Voffset is applied to the first electrodes 220 and 320 and the second electrodes 280 and 350, the light emission from the light emitting element layers 230 and 325 is stopped. For example, the offset voltage Voffset may be a voltage of about 0 V or higher.

In this way, the reflective element layers 270 and 345, and the light emitting element layers 230 and 325 are different from each other in frequency of the driving voltage. Accordingly, the reflecting mode or the light emission mode may be easily realized by changing the frequency of voltages applied to the first electrodes 220 and 320 and the second electrodes 280 and 350.

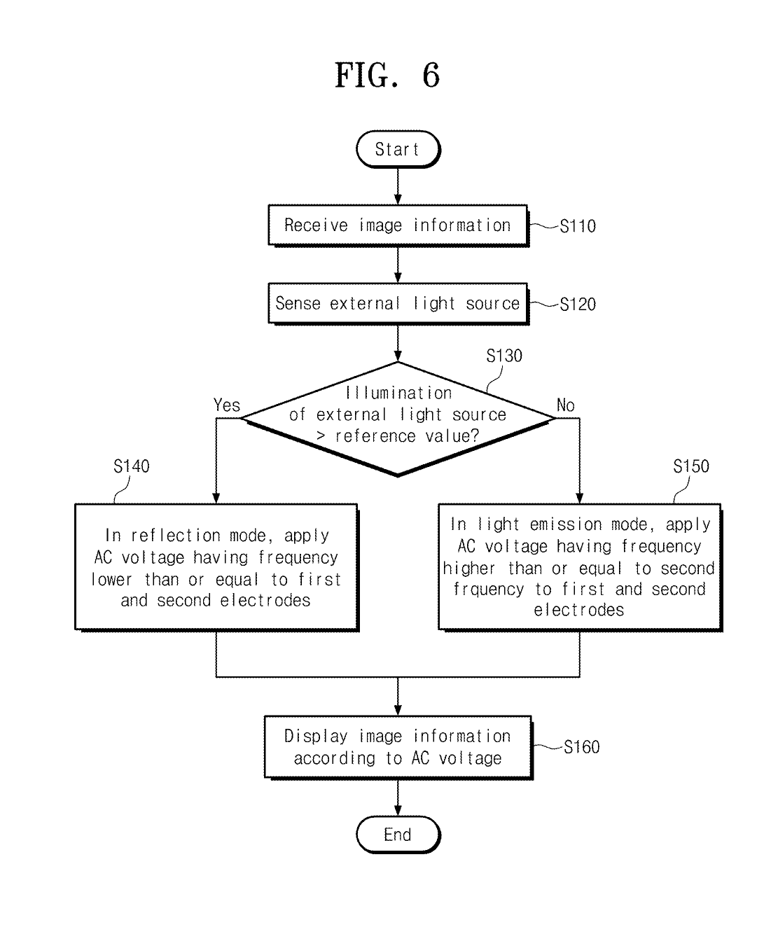

FIG. 6 is a flowchart showing an operation method of a display device according to an embodiment of the inventive concept. Referring to FIGS. 1 to 6, the display device 100 may selectively drive the reflection mode or light emission mode of the pixels PX11 to PXnm according to illumination of the external light source.

The timing controller (not illustrated) may receive image information. The timing controller (not illustrated) may generate a data signal for driving the pixels PX11 to PXnm according to the image information (operation S110). An optical sensor (not illustrated) may sense an external light source. The optical sensor (not illustrated) may generate illumination information according to the illumination of the external light source (operation S120).

The timing controller (not illustrated) may compare the illumination of the external light source with a preset reference value according to the illumination information (operation S130). When the illumination of the external light source is greater than the reference value, the process moves to operation S140. When the illumination of the external light source is smaller than or equal to the reference value, the process moves to operation S150.

When the illumination of the external light source is greater than a preset reference value, the pixels PX11 to PXnm are driven in a reflection mode. In detail, in the reflection mode, AC voltage having a frequency lower than or equal to a first frequency may be applied to the first electrodes 220 and 320 and the second electrodes 280 and 350 of the pixels 200 and 300 (operation S140). In the AC voltage having the frequency lower than or equal to the first frequency, an oxidation and a reduction occur in the reflective element layers 270 and 345 to realize the reflection mode.

When the illumination of the external light source is smaller than or equal to the preset reference value, the pixels PX11 to PXnm are driven in the light emission mode. In detail, in the light emission mode, AC voltage having the frequency higher than or equal to a second frequency may be applied to the first electrodes 220 and 320 and the second electrodes 280 and 350 of the pixels 200 and 300 (operation S150). In the AC voltage having the frequency higher than or equal to the second frequency, an oxidation and a reduction occur in the reflective element layers 230 and 325 to realize the light emission mode.

The pixels PX11 to PXnm may be selectively driven in the reflection mode or the light emission mode according to the AC voltage, which are applied to the first electrodes 220 and 320 and the second electrodes 280 and 350, to display the image information (operation S160).

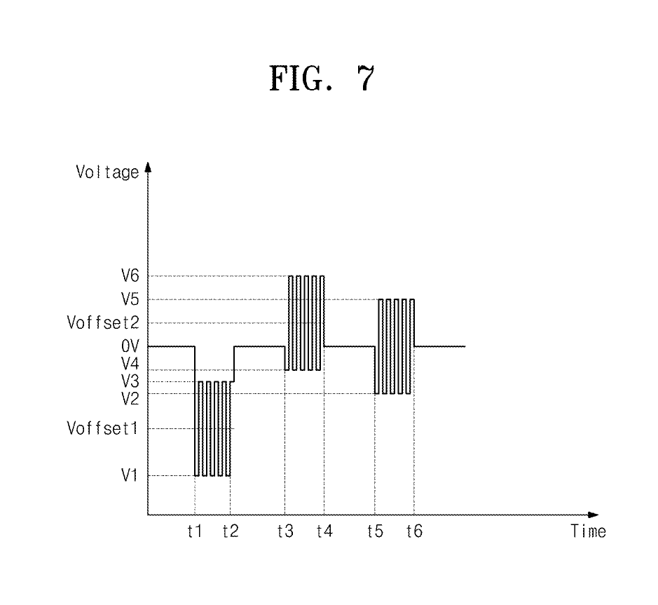

FIG. 7 is a flowchart showing a voltage signal applied in a composite mode according to an embodiment. Referring to FIGS. 1 to 5, and 7, when the AC voltage is applied to the first electrodes 220 and 320 and the second electrodes 280 and 350 of the pixels PX11 of PXnm, the pixels PX11 to PXnm may be compositely driven in the reflection mode and the light emission mode.

From the first time t1 to the second time t2, a first voltage V1 and a third voltage V3 are applied with a period of a second frequency of higher. According to an embodiment, both the first and third voltages V1 and V3 are negative. The first and third voltages V1 and V3 are applied during the first period T1. Since a first offset voltage Voffset1, which is an average voltage of the first and third voltages V1 and V3, is negative, the reflective element layer 270 and 345 may be colored red, green, blue, or black by a reduction.

In the reflective element layers 230 and 325, a reduction occurs and radical anions may be generated in a phosphor, which develops a color of green, blue, or black. However, since a positive voltage is not applied, radical cations are not generated. Accordingly, the light emitting element layers 230 and 325 do not emit light.

From the second time t2 till a third time t3, a voltage of 0 V is applied to the first electrodes 220 and 320 and the second electrodes 280 and 350. In addition, it is a state where the reduction may occur in the material defining the reflective element layers 270 and 345. Accordingly, in this period, the reflective element layers 270 and 345 continuously exhibit the reflection mode.

From the third time t3 to a fourth time t4, a fourth voltage V4 and a sixth voltage V6 are applied to the first electrodes 220 and 320 and the second electrodes 230 and 350 with a period of a second frequency or higher. According to an embodiment of the inventive concept, the fourth voltage V4 is negative, and a sixth voltage V6 is positive. A second offset voltage Voffset2, which is an average value of the fourth and sixth voltages V4 and V6, is positive. Accordingly, the reflective element layers 270 and 345 may be bleached to a transparent state by an oxidation. In this period, the reflective element layers 270 and 345 terminate the reflection mode.

In addition, till the fourth time t4, the fourth voltage V4 and the sixth voltage V6 are applied to the first electrodes 220 and 320 and the second electrodes 280 and 350 with a period of the second frequency or higher, radical anions and radical cations are generated in the light emitting element layers 230 and 325 by the oxidation and reduction. The light emitting element layers 230 and 325 emit light due to collision combination of the radial anions and the radial cations.

From the fourth time t4 to a fifth time t5, when about 0 V is applied to the first electrodes 220 and 320 and the second electrodes 280 and 350, the light emission from the light emitting element layers 230 and 325 is stopped.

From the fifth time t5 to a sixth time t6, the second voltage V2 and the fifth voltage V5 are applied to the first electrodes 220 and 320 and the second electrodes 230 and 350 with a period of a second frequency or higher. According to an embodiment of the inventive concept, the second voltage V2 is negative, and a fifth voltage V5 is positive. At this point, the pixels PX11 to PXnm are driven as described in relation to FIG. 5.

As shown in FIG. 7, the reflection mode and the light emission mode of the pixels PX11 to PXnm may be simultaneously realized by changing the magnitude of the offset voltage Voffset of an AC voltage applied to the first electrodes 220 and 320 and the second electrodes 280 and 350 of the pixels PX11 to PXnm.

According to an embodiment, a display device may be efficiently driven by selectively realizing a reflection mode or a light emission mode of a display panel by adjusting a frequency of an AC voltage applied to two substrates of the display panel.

As described above, exemplary embodiments have been disclosed in this specification and the accompanying drawings. Although specific terms are used herein, they are just used for describing the present disclosure, but do not limit the meanings and the scope of the present invention disclosed in the claims. Accordingly, those skilled in the art will appreciate that various modifications and other equivalent embodiments can be derived from the exemplary embodiments of the present disclosure. Therefore, the scope of true technical protection of the present disclosure should be defined by the technical idea of the appended claims.

What is claimed is:

1. A display panel comprising:
a plurality of pixels, each of the plurality of pixels being configured to be driven in either a reflection mode or a light emission mode,
wherein each of the plurality of pixels comprises:
a first substrate comprising a light-transmitting material;
a second substrate opposite to the first substrate;
a first electrode on a surface of the first substrate in a direction of the second substrate;
a light emitting element layer on the first electrode, the light emitting element layer comprising a light emitting material, the light emitting material being configured to emit light in the light emission mode by an oxidation of the light emitting material and a reduction of the light emitting material;
a second electrode on a surface of the second substrate in a direction of the first substrate;
a reflective element layer on the second electrode, the reflective element layer comprising a reflective material, the reflective material being configured to be colored or bleached in the reflection mode by an oxidation of the reflective material and a reduction of the reflective material; and
an electrolyte layer between the light emitting element layer and the reflective element layer, the electrolyte layer being configured to adjust transmissivity of the light,
wherein in the reflection mode, a first alternating current (AC) voltage having a frequency lower than or equal to a first frequency is applied to the first and second electrodes,
wherein in the light emission mode, a second AC voltage having a frequency higher than or equal to a second frequency is applied to the first and second electrodes, and
wherein the second frequency is higher than the first frequency.

2. The display panel of claim 1, wherein in the reflection mode:
when a first reflection voltage is applied to the first and second electrodes, the reflective material is colored by the reduction of the reflective material, and
when a second reflection voltage is applied to the first and second electrodes, the reflective material is bleached by the oxidation of the reflective material, and
wherein the first reflection voltage is a negative voltage and the second reflection voltage is a positive voltage.

3. The display panel of claim 2, wherein the reflective material is colored by one of red, green, blue, and black, and
wherein the reflective material reflects the light applied from an outside.

4. The display panel of claim 1, wherein in the light emission mode:
when a first light emission voltage is applied to the first and second electrodes, the reduction of the light emitting material occurs at the light emitting element layer, and
when a second light emission voltage is applied to the first and second electrodes, the oxidation of the emitting material occurs at the light emitting element layer,
wherein the light emitting element layer emits the light by the oxidation of the light emitting material and the reduction of the light emitting material, and
wherein the first light emission voltage is a negative voltage and the second emission voltage is a positive voltage.

5. The display panel of claim 4, wherein an average voltage of the first and second light emission voltages is higher than or equal to 0 V.

6. The display panel of claim 1, further comprising:
a first insulating layer between the first substrate and the first electrode; and
a second insulating layer between the second substrate and the second electrode.

7. The display panel of claim 1, further comprising a plurality of spacers between the first and second substrates.

8. An operation method of a display device, the display device being configured to be driven in either a reflection mode or a light emission mode, the operation method comprising:
measuring, by an optical sensor of the display device, an illumination of a light source;
comparing, by a timing controller of the display device, a reference value with the illumination;
in response to the illumination being compared to be greater than the reference value, applying, by the timing controller of the display device, a first alternative current (AC) voltage having a frequency lower than or equal to a first frequency to a first electrode and a second electrode of each pixel of the display device to realize the reflection mode; and
displaying image information on the display device according to the first AC voltage.

9. The operation method of claim 8, further comprising:
in response to the illumination being compared to be smaller than or equal to the reference value, applying a second AC voltage having a frequency higher than or equal to a second frequency to the first electrode and the second electrode of the each pixel to realize the light emission mode.

10. The operation method of claim 9, wherein the second frequency has a higher level than a level of the first frequency.

11. A display device comprising:
a display panel comprising a plurality of pixels, each of the plurality of pixels being configured to be driven in either a reflection mode or a light emission mode; and
a circuit board configured to:
sense a light source,
compare an illumination of the light source with a reference value and generate a comparison result, and
adjust a first alternating current (AC) voltage and a second AC voltage applied to the plurality of pixels in response to the comparison result,
wherein each of the plurality of pixels comprises:
a first substrate comprising a light-transmitting material;
a second substrate opposite to the first substrate;
a first electrode on a surface of the first substrate in a direction of the second substrate;
a light emitting element layer on the first electrode, the light emitting element layer comprising a light emitting material, the light emitting material being configured to emit light in the light emission mode by an oxidation of the light emitting material and a reduction of the light emitting material;
a second electrode on a surface of the second substrate in a direction of the first substrate;
a reflective element layer on the second electrode, the reflective element layer comprising a reflective material, the reflective material being configured to be colored and bleached in the reflection mode by an oxidation of the reflective material and a reduction of the reflective material; and
an electrolyte layer between the light emitting element layer and the reflective element layer, the electrolyte layer being configured to adjust transmissivity of the light,
wherein when the illumination is greater than the reference value, the first AC voltage having a frequency lower than or equal to a first frequency is applied to the first and second electrodes to drive the plurality of pixels in the reflection mode,
wherein when the illumination is smaller than or equal to the reference value, the second AC voltage having a frequency higher than or equal to a second frequency is applied to the first and second electrodes to drive the plurality of pixels in the light emission mode, and
wherein the second frequency is higher the first frequency.
